(19) United States
(12) Patent Application Publication
(10) Pub. No.: US 2023/0390694 A1
(43) Pub. Date: Dec. 7, 2023

(54) EXHAUST GAS TREATMENT FACILITY

(71) Applicant: KURITA WATER INDUSTRIES LTD., Tokyo (JP)

(72) Inventors: Shingo Harashima, Tokyo (JP); Nozomu IKUNO, Tokyo (JP)

(73) Assignee: KURITA WATER INDUSTRIES LTD., Tokyo (JP)

(21) Appl. No.: 18/034,061

(22) PCT Filed: Oct. 26, 2021
(86) PCT No.: PCT/JP2021/039494

§ 371 Date: Apr. 27, 2023

(30) Foreign Application Priority Data
Oct. 30, 2020 (JP) 2020-182715
Feb. 10, 2021 (JP) 2021-019965

(51) Int. Cl. B01D 53/18; C02F 1/66; B01D 53/14

(52) U.S. Cl. CPC B01D 53/185; C02F 1/66; B01D 53/1493; B01D 2258/0216; B01D 2252/2053; B01D 2252/102; B01D 2252/103; C02F 2209/06

(57) ABSTRACT

An exhaust gas treatment facility includes: a combustion chamber for combustion-treating an exhaust gas; a nozzle for letting water flow along an inner wall surface of the combustion chamber; a water-feeding line for supplying water to the nozzle; a primary gas-cleaning chamber; a scrubber; and the like. The water-feeding line has a pipe, a pump, and pipes. An alkali-adding apparatus is provided on the pipe on an upstream side of the pump. The alkali-adding apparatus is controlled so as to regulate a detected pH by a pH meter to be 10 or higher.

### TECHNICAL FIELD

The present invention relates to an exhaust gas treatment facility (detoxifying apparatus) for treating exhaust gas from a semiconductor production process and the like with detoxifying combustion and the like.

### BACKGROUND ART

Exhaust gas containing a perfluoro compound and the like is discharged from production processes of semiconductors, liquid crystals, LEDs, solar cells, and the like. In this exhaust gas, CH₂F₂, WF₆, BCl₃, Cl₂, F₂, HF, SiH₄, NH₃, PH₃, TEOS (tetraethoxysilane), TRIS (triethoxysilane), TiCl₄, and the like may be contained. In an exhaust gas treatment facility (detoxifying apparatus) treating such exhaust gas, the perfluoro compound and the like are burned (oxidized) or subjected to a pyrolysis reaction by using combustion, electric heating, plasma, and the like, and then the exhaust gas is cleaned through a scrubber to remove water-soluble components, such as F₂, and fine particles in the gas.

As this combustion treatment apparatus for exhaust gas, there is one configured to spray water with a spray nozzle on a downstream side of a combustion chamber to cool the gas (PTL1). In addition, there is a water-cooling combustion-type detoxifying apparatus configured that water flows down along an inner wall surface of a combustion chamber to prevent adhesion of a combustion product onto the inner wall surface and to protect the inner wall surface from combustion heat (PTL2).

### CITATION LIST

### Patent Literature

PTL1: JP 2017-26244 A

PTL2: JP 2003-24741 A

### SUMMARY OF INVENTION

### Technical Problem

In conventional detoxifying apparatuses, a sedimentation product is likely to be generated inside the detoxifying apparatus or on a scrubber, a pipe, and the like, and an operation stop of the detoxifying apparatus to remove the sedimentation product is required. As the sedimentation product, solids such as a silica-based or tungsten-based oxide can be mentioned, but other solids are also generated.

An object of the present invention is to suppress the generation of the sedimentation product in the exhaust gas treatment facility.

### Solution to Problem

Exhaust gas treatment facilities of a first invention are the following [1] to [4], and exhaust gas treatment facilities of a second

invention are the following [5] to [10].
[1] An exhaust gas treatment facility, comprising: a combustion chamber for combustion-treating an exhaust gas; a water-outflowing means for letting water flow along an inner wall surface of the combustion chamber; and a water-feeding means for supplying water to the water-outflowing means,
wherein an alkali-adding means for adding an alkali is provided on the water-feeding means.
[2] The exhaust gas treatment facility according to [1], wherein the water-feeding means comprises a pump for feeding water, a first pipe connected to an inlet side of the pump, and a second pipe connected to an outlet side of the pump, and
the alkali-adding means is provided so as to add the alkali into the first pipe.
[3] The exhaust gas treatment facility according to [2], wherein a pH meter is provided on the second pipe, and a control means for controlling an amount of the alkali to be added with the alkali-adding means so as to regulate a detected pH by the pH meter within a predetermined range is provided.
[4] The exhaust gas treatment facility according to [3], wherein the predetermined range is a pH of 9 or higher.
[5] An exhaust gas treatment facility, comprising: a detoxifying apparatus for detoxification-treating an exhaust gas; and a water-feeding means for supplying water to the detoxifying apparatus,
wherein a chemical agent-adding means for adding choline and/or ammonia into water to be supplied to the water-feeding means is provided.
[6] The exhaust gas treatment facility according to [5], wherein the chemical agent-adding means adds choline and/or ammonia, and also hydrogen peroxide into the water.
[7] The exhaust gas treatment facility according to [5] or [6], wherein
a scrubber is provided on a downstream side of the detoxifying apparatus, and
a chemical agent-adding means for adding choline and/or ammonia into water for the scrubber is provided.
[8] The exhaust gas treatment facility according to [7], wherein choline and/or ammonia and also hydrogen peroxide are added into water for the scrubber.
[9] The exhaust gas treatment facility according to any of [5] to [8], wherein the chemical agent-adding means adds, as a chemical agent, a solution used in a semiconductor production process or a drainage water of a semiconductor production process.
[10] The exhaust gas treatment facility according to any of [5] to [9], wherein the exhaust gas is an exhaust gas from a semiconductor production process.

### Advantageous Effects of Invention

According to the first invention, by setting the water to be supplied to the exhaust gas treatment facility to be alkaline, the generation of the sedimentation product in the exhaust gas treatment facility is suppressed. This can reduce a number of times of maintenance of the exhaust gas treatment facility. In addition, a stop of a production process machine of semiconductors and the like can be prevented whereby enhancing productivity of the semiconductors and the like.

According to the second invention, by adding choline and/or ammonia or further adding hydrogen peroxide into the water to be supplied to the detoxifying apparatus or the scrubber, the generation of the sedimentation product in the exhaust gas treatment facility is suppressed. This can reduce a number of times of maintenance of the exhaust gas treatment facility. In addition, a stop of a production process machine of semiconductors and the like can be prevented whereby enhancing productivity of the semiconductors and the like.

When the exhaust gas is an exhaust gas from the semiconductor production process, the sedimentation product in the detoxifying apparatus contains silica, tungsten, and oxides thereof as main components. In particular, tungsten and the oxide thereof are dissolved relatively well in the solution containing choline and/or ammonia or further containing hydrogen peroxide. Thus, the sedimentation product is easily removed.

### BRIEF DESCRIPTION OF DRAWINGS

FIG. 1 is a block diagram of an exhaust gas treatment facility according to an embodiment of the first invention.

FIG. 2 is a block diagram of an exhaust gas treatment facility according to an embodiment of the second invention.

### DESCRIPTION OF EMBODIMENTS

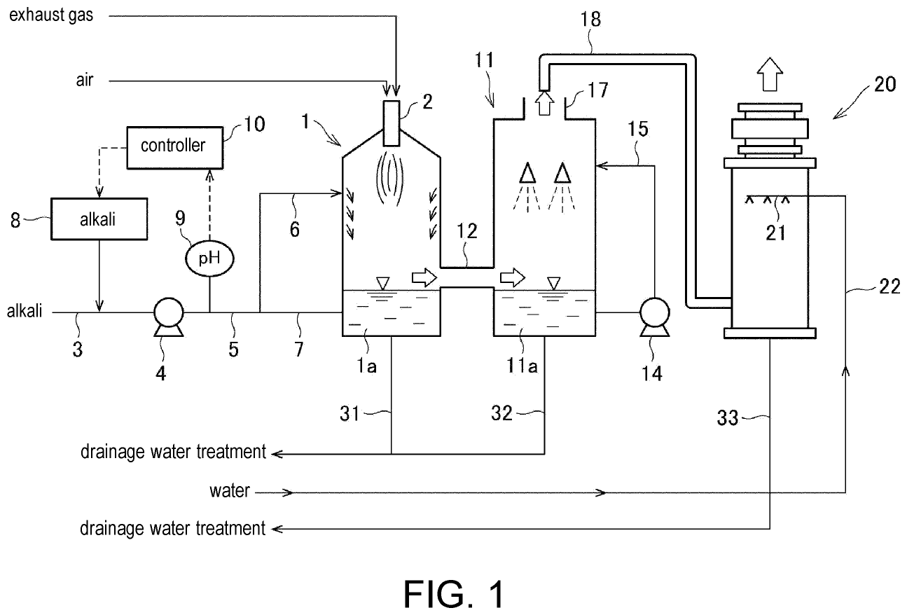

Hereinafter, the embodiment of the first invention will be described with reference to FIG. 1. An exhaust gas from a semiconductor production process and air from a blower are supplied to a burner 2 provided on an upper part of a tower-shaped combustion chamber 1, and the exhaust gas is incinerated in the combustion chamber 1.

A nozzle (illustration omitted) is provided so as to let water flow along an inner wall surface of the combustion chamber 1, and the water is supplied with a water-feeding line to the nozzle. The water flowing out through this nozzle flows down as a water film on the inner wall surface of the combustion chamber 1 whereby protecting the inner wall surface from combustion heat. The water flowing on the inner wall surface of the combustion chamber 1 as a water film absorbs a water-soluble component in the combustion gas and traps fine particles. In addition, the water lowers the gas temperature.

The water flowing down on the inner wall surface is collected in a pit 1a of a bottom of the combustion chamber.

The water-feeding line to the nozzle has a pipe 3, a pump 4, a pipe 5, and pipes 6 and 7 branched from the pipe 5. The pipe 6 is connected to the nozzle, and the pipe 7 is provided so as to feed water to the pit 1a of the bottom of the combustion chamber 1.

An alkali-adding apparatus 8 is provided so as to add an alkaline aqueous solution into the pipe 3. As the alkali, an aqueous solution of sodium hydroxide, potassium hydroxide, ammonia, or the like is preferable. On the pipe 5, a pH meter 9 to detect a pH of the water flowing in the pipe 5 is provided.

By adding the alkali into the pipe 3 on an upstream side of the pump 4, the alkali added and water are sufficiently stirred and mixed with the pump 4.

A detection signal of the pH meter 9 is input to a controller 10 to control the alkali-adding apparatus 8 so as to regulate the detected pH by the pH meter 9 within a target range.

In the present invention, the alkali is preferably added so as to regulate the pH of the water to be supplied to the combustion chamber 1 to be a pH of 9 or higher, preferably a pH of 9 to 12, particularly preferably a pH of 10 to 12. With considering alkali resistance of apparatuses and members of the exhaust gas treatment facility, the alkali may be added so as to regulate a lower pH than the above (for example, 8 to 9).

A primary gas-cleaning chamber 11 is provided adjacent to the combustion chamber 1. A lower part of the combustion chamber 1 and a lower part of the primary gas-cleaning chamber 11 are communicated with each other with a duct 12. The gas from the combustion chamber 1 is introduced through the duct 12 to the primary gas-cleaning chamber 11 and to rise in the primary gas-cleaning chamber 11.

A part of the water in the pit 1a of the combustion chamber 1 flows out by overflow through the duct 12 to a pit 11a of the primary gas-cleaning chamber 11. A part of the water in the pit 1a of the combustion chamber 1 may be transferred to the pit 11a with a water-transferring pipe other than the duct 12.

The water in the pit 11a of the bottom of the primary gas-cleaning chamber 11 is sprinkled into the apparatus with a scrubber via the pump 14 and the pipe 15. The gas rising in the primary gas-cleaning chamber 11 is contacted with the water flowing from the scrubber, and a water-soluble component and fine particles in the gas are absorbed or trapped in the water.

The gas passing through the water scrubber is introduced from a gas outlet 17 through a duct 18 to a scrubber 20.

The water is supplied through a pipe 22 to a nozzle 21 on an upper part in the scrubber 20. The gas is contacted with the sprinkled water through the nozzle 21, the water-soluble component and fine particles are adsorbed or trapped in the water, and then the gas flows out through the scrubber 20.

Water in the combustion chamber 1, the primary gas-cleaning chamber 11, and the bottom of the scrubber 20 is taken out via pipes 31, 32, and 33, and transferred to a drainage water treatment facility (illustration omitted) and treated.

In this exhaust gas treatment facility, since the alkaline water is supplied to the combustion chamber 1 as above, generation of a sedimentation product on the inner wall surface or in the pit 1a of the combustion chamber 1, in the pit 11a of the primary gas-cleaning chamber 11, on a contacting material 13, in the drainage water pipes 31 and 32, and the like is suppressed. Thus, a frequency of maintenance of the exhaust gas treatment facility is reduced. In addition, an operation stop of the semiconductor production process involved with a stop of the exhaust gas treatment facility is prevented to enhance productivity of a product.

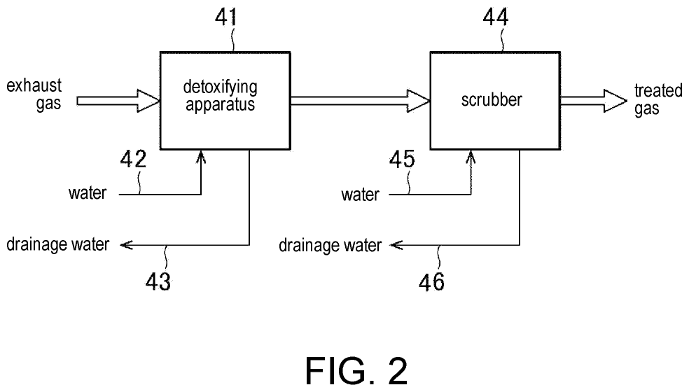

Hereinafter, the embodiment of the second invention will be described with reference to FIG. 2. An exhaust gas from a semiconductor production process is supplied to a detoxifying apparatus 41, and the exhaust gas is combustion- or decomposition-treated. The detoxifying apparatus may be any of combustion-type, plasma-type, electric heating-type apparatuses, and the like, and may also be another type apparatus.

In the detoxifying apparatus 41, a nozzle (illustration omitted) is provided so as to spray water or to let the water flow along an inner wall surface of the detoxifying apparatus 41. The water is supplied to the nozzle with a water-feeding line 42 equipped with a tank, a pipe, and the like, and the water is sprayed through the nozzle or the water flowing out through the nozzle flows on the inner wall surface of the detoxifying apparatus 41 as a water film. This sprayed water or water flowing on the inner wall surface absorbs a water-soluble component in the gas, and traps fine particles or lowers the gas temperature.

The gas treated with the detoxifying apparatus 41 is transferred to a scrubber 44, subjected to a gas-cleaning treatment, and then transferred to the next step or discharged to the air.

In the scrubber 44, water is supplied to a nozzle of an upper part. The gas is contacted with the water sprinkled through the nozzle, the water-soluble component and fine particles are absorbed or trapped in the water, and then the gas flows out through the scrubber 44. The water is supplied to the scrubber 44 with a water-feeding line 45 equipped with a tank, a pipe, and the like.

Water taken out from the detoxifying apparatus 41 and a bottom of the scrubber 44 is taken out via drainage water-feeding lines 43 and 46, and transferred to a drainage water treatment facility (illustration omitted) and treated.

In the present embodiment, a chemical agent-adding apparatus is provided so as to add a solution of choline and/or ammonia into the water transferred to the detoxifying apparatus 41 and the scrubber 44 via the water-feeding lines 42 and 45.

As the chemical agent-adding apparatus, a common apparatus having a tank of the chemical agent solution, a chemical injection pump, and a controller of the chemical injection pump can be used, but the apparatus is not limited thereto. The chemical agent-adding apparatus may add the chemical agent to both the water-feeding lines 42 and 45, or each of the chemical agent-adding apparatus may be provided on the water-feeding lines 42 and 45.

As the chemical agent solution, a choline solution, an ammonia solution, or a mixed solution thereof with hydrogen peroxide is used. In this case, as the mixed solution of ammonia and a hydrogen peroxide, SC-1, which is used as a washing liquid in the semiconductor production process, and drainage water thereof can also be used. With considering an effect on the detoxifying apparatus 41, the scrubber 44, and peripheral members thereof, a corrosion inhibitor may be used in combination.

In the present invention, the chemical agent solution may be continuously added into the water for the detoxifying apparatus and scrubber, or the chemical agent may be temporarily added to the water for the purpose of removal of the sedimentation product. In any cases, the purposes of the dissolution and generation suppression of the sedimentation product are sufficiently achieved.

An addition rate of choline is preferably 0.1 to 10 g/L, and particularly preferably approximately 1 to 10 g/L. An addition rate of ammonia is preferably 0.1 to 10 g/L, and particularly preferably approximately 1 to 10 g/L. An addition rate of the hydrogen peroxide is preferably 0.1 to 10 g/L, and particularly preferably approximately 1 to 10 g/L. For the purpose of dissolution of the sedimentation product, the addition rate is preferably approximately 1 to 10 g/L. For the purpose of generation suppression of the sedimentation product, the addition rate is preferably approximately 0.1 to 1 g/L.

As noted above, by adding the chemical agent into the water for the detoxifying apparatus 41 and scrubber 44, silica, tungsten, and oxides thereof, which are main components of the sedimentation product can be dissolved. This can suppress or solve clogging inside the detoxifying apparatus 41 and scrubber 44, in the peripheral pipes of the detoxifying apparatus and the like, which can attempt to enhance the productivity and reduce the maintenance frequency. In addition, an operation stop of the semiconductor production process involved with a stop of the exhaust gas treatment facility is prevented to enhance productivity of a product.

### Example

To demonstrate that choline and/or ammonia had a sufficient dissolution property, the following experiments were performed. A sedimentation product was collected form a scrubber provided at a later stage of a detoxifying apparatus in a semiconductor production process. The component was analyzed, and a content rate of W was approximately wt % on the dry basis.

The sedimentation product immediately after the collection was added and dispersed in pure water so that a solid content concentration was 0.1% to prepare a test solution (sample water).

Into this test solution, choline, choline+H₂O₂, ammonia, or ammonia+H₂O₂ was each added as a chemical agent at an addition rate of choline 0.1% (wt %, the same applies hereinafter), choline 0.05%+H₂O₂ ammonia 0.1%, or ammonia 0.05%+H₂O₂ 0.05%. The mixture was stirred for 10 minutes, and then an amount of an undissolved solid content was measured to measure a dissolution rate. The dissolution rates were approximately 50 to 60% in any cases of choline, choline+H₂O₂, and ammonia+H₂O₂. The dissolution rate in the case of the addition of ammonia 0.1% was approximately 70%.

When an addition rate of each of the chemical agents was 1% relative to the test solution, the dissolution rates were approximately 75 to 90%.

In contrast, a dissolution rate in a case where NaOH 0.1% was added was approximately 20%, and a dissolution rate even in a case where NaOH 1% was added was as low as approximately 45%. From the results, choline and/or ammonia have been demonstrated to have sufficient dissolution property.

The above embodiments are an example of the present invention, and the present invention may be an embodiment other than the above.

The present invention has been described in detail by using specific aspects, but it is obvious for persons skilled in the art that various modifications can be made without departing from the spirit and scope of the present invention.

The present application is based on Japanese Patent Application No. 2020-182715, filed on Oct. 30, 2020, and Japanese Patent Application No. 2021-019965, filed on Feb. 10, 2021, and the entirety of which is hereby incorporated by reference.

### REFERENCE SIGNS LIST

1 Combustion chamber
2 Burner
4, 14 Pump
8 Alkali-adding apparatus
11 Primary gas-cleaning chamber
20 Scrubber
41 Detoxifying apparatus
44 Scrubber

1. An exhaust gas treatment facility, comprising: a combustion chamber for combustion-treating an exhaust gas; a water-outflowing means for letting water flow along an inner wall surface of the combustion chamber; and a water-feeding means for supplying water to the water-outflowing means,
wherein an alkali-adding means for adding an alkali is provided on the water-feeding means.

2. The exhaust gas treatment facility according to claim 1, wherein
the water-feeding means comprises a pump for feeding water, a first pipe connected to an inlet side of the pump, and a second pipe connected to an outlet side of the pump, and
the alkali-adding means is provided so as to add the alkali into the first pipe.

3. The exhaust gas treatment facility according to claim 2, wherein a pH meter is provided on the second pipe, and a control means for controlling an amount of the alkali to be added with the alkali-adding means so as to regulate a detected pH by the pH meter within a predetermined range is provided.

4. The exhaust gas treatment facility according to claim 3, wherein the predetermined range is a pH of 9 or higher.

5. An exhaust gas treatment facility, comprising: a detoxifying apparatus for detoxification-treating an exhaust gas; and a water-feeding means for supplying water to the detoxifying apparatus,
wherein a chemical agent-adding means for adding choline and/or ammonia into water to be supplied to the water-feeding means is provided.

6. The exhaust gas treatment facility according to claim 5, wherein the chemical agent-adding means adds choline and/or ammonia, and also hydrogen peroxide into the water.

7. The exhaust gas treatment facility according to claim 5, wherein
a scrubber is provided on a downstream side of the detoxifying apparatus, and
a chemical agent-adding means for adding choline and/or ammonia into water for the scrubber is provided.

8. The exhaust gas treatment facility according to claim 7, wherein choline and/or ammonia and also hydrogen peroxide are added into water for the scrubber.

9. The exhaust gas treatment facility according to claim 5, wherein the chemical agent-adding means adds, as a chemical agent, a solution used in a semiconductor production process or a drainage water of a semiconductor production process.

10. The exhaust gas treatment facility according to claim 5, wherein the exhaust gas is an exhaust gas from a semiconductor production process.
